(19) United States
(12) Patent Application Publication
(10) Pub. No.: US 2006/0192729 A1
(43) Pub. Date: Aug. 31, 2006

(54) Display device with flexible substrate and shift register

(75) Inventors: Eugenio Cantatore, Eindhoven (NL); Gerwin H. Gelinck, Valkenswaard (NL); Hjalmar E.A. Huitema, Veldhoven (NL); Dagobert M. De Leeuw, Eersel (NL); Bas J.E. Van Rens, Son (NL)

Correspondence Address: PHILIPS INTELLECTUAL PROPERTY & STANDARDS, P.O. BOX 3001, BRIARCLIFF MANOR, NY, 10510, US

(73) Assignee: Koninklijka Philips Electronics N.V.

(21) Appl. No.: 10/568,648

(22) PCT Filed: Aug. 12, 2004
(86) PCT No.: PCT/IB04/02641

§ 371 Date: Feb. 16, 2006

(30) Foreign Application Priority Data
Aug. 19, 2003 (GB) 0319409.9

(51) Int. Cl. G09G 3/20

(52) U.S. Cl. 345/55

(57) ABSTRACT

A matrix array display device (100) is mounted on a flexible substrate (110) such as a polyimide substrate, and has a plurality of first conductors (120) crossing a plurality of second conductors (130), with a plurality of pixels (140) being located in the vicinity of a crossing between a first conductor (120) and a second conductor (130). The display device (100) includes a flexible shift register (150) and an optional further flexible shift register (160) for addressing the first conductors (120). The flexible shift register (150), which preferably is realized using organic semiconductor materials, occupies a smaller area of the flexible substrate (110) than for instance a bus structure, thus increasing the effective display area of the display device (100).

The present invention relates to a matrix array display device having a flexible substrate carrying the matrix array.

The present invention further relates to an electronic device being arranged to control such a matrix array display device.

Flexible display devices, that is, display devices that can be rolled up to significantly reduce the size of the display device in an unused state, are increasingly becoming the topic of research efforts. An example of such a display device is disclosed in Applied Physics Letters, volume 78, number 23, page 3592-3594 of 2001.

One of the reasons for this increasing interest is that such display devices can be useful in a wide range of application domains. One of such application domains is the mobile phone market, where it is advantageous to have a large display area when the phone is used to access information from the internet or to display video data streams.

The flexibility of such display devices is typically obtained by using flexible materials such as organic polymer materials for several parts of the display device such as the substrate and the thin film transistors in case of an active matrix array display device. To maintain a large degree of flexibility, the control circuitry for controlling the matrix array is preferably located on a single side of the flexible matrix array display device. Obviously, the connections to the conductors of the matrix array that run substantially perpendicular to the control circuitry is much more straightforward than the connections to the conductors of the matrix array that run substantially parallel to the control circuitry. Usually, the conductors that run in parallel with the control circuitry are connected to the control circuitry by including a plurality of conductive connecting tracks on one or two of the flexible sides of the display device, the conductive tracks running in parallel with the second conductors and each of the conductive tracks connecting a first conductor to the control circuitry.

However, when the number of rows in such a display device is becoming large, the connecting tracks consume a considerable amount of image display area, which is an unwanted effect.

Having a large number of connecting tracks has an additional disadvantage. An intrinsic problem with organic materials is that they are sensitive to air and moisture, which limits the lifetime of the display device. This can be solved by enveloping the display device in a protective layer, but this has the disadvantage that such a layer has a detrimental effect on the flexibility of the display device and increases the overall cost of the display device. Alternatively, the display device is left unprotected, in which case the display device will have a limited lifetime. The limited lifetime, however, is not a major disadvantage because the cost of unprotected flexible display devices can be kept low, which means that replacement display devices can be marketed at affordable prices. However, it is desirable that such a disposable display device can be replaced easily. Having a large number of connections between the display device and the control circuitry complicates the interchangeability of such display devices, which is also unwanted.

It is an object of the present invention to provide an improved flexible display device.

It is another object of the present invention to provide an electronic device for controlling the improved flexible display device.

According to a first aspect of the invention, there is provided a matrix array display device, comprising a flexible substrate carrying a matrix array comprising a plurality of first conductors; a plurality of second conductors, each of the second conductors crossing the plurality of first conductors and a plurality of pixels, each pixel being located in the vicinity of a crossing of a first conductor and a second conductor, the pixel comprising a electro-optical element being addressable by the first conductor and the second conductor, the display device further comprising a flexible shift register for addressing the plurality of first conductors, the flexible shift register comprising a plurality of shift register cells, each shift register cell being coupled to one of the first conductors.

The use of a flexible shift register has the advantage that all the necessary signals for the first conductors can be provided via a minimum of three external connections; two connections for the power supply and a third connection for the clock signals that shift the data signals from the shift register cells to the corresponding first conductors. The data may be generated on the flexible display device in case of the first conductors being row conductors, or may be provided to the shift register via a further external connection. Consequently, a display device is realized requiring fewer connections and having a larger effective image display area than prior art display devices on flexible substrates. This particularly holds for display devices wherein each pixel comprises a switch coupled between the associated second conductor and the electro-optical element, the switch comprising an organic semiconductor material and a control terminal coupled to the associated first conductor, i.e., active matrix array display devices having flexible, organic, TFTs, which usually have a large number of first conductors.

Advantageously, each shift register cell comprises a plurality of further switches, each further switch comprising a further organic semiconductor material. The use of organic switches, e.g., transistors, increases the flexibility of the shift register.

In an embodiment, the shift register is carried by the flexible substrate. This is particularly advantageous in case of an active matrix array display device, because the switches in the pixels and the further switches of the shift register can be realized in the same technology, thus reducing the cost of the display device.

In an alternative embodiment, the shift register is carried by a further flexible substrate, the further flexible substrate being bonded to a first side of the flexible substrate. This has the advantage that the overall yield of the production process of the display device is increased because the production process of the matrix array and the production process of the shift register can be separated from each other, in which case a production error in one of these two parts does not automatically lead to the failure of the whole display device. In addition, the separate production process also allows for the use of different semiconductor materials or different fabrication processes for the switches in the pixels of an active matrix array and the further switches of the shift register, which can be chosen to optimize the performance of the various switches. Also, the use of a further substrate is advantageous in the case of a passive matrix array display device, because the cheap production process of the passive matrix can be separated from the more expensive production process of the further substrate on which a substantial number of further switches have to be formed to implement the shift register functionality.

It is a further advantage if the display device further comprises a further flexible shift register for addressing the plurality of first conductors, the further flexible shift register comprising a plurality of further shift register cells, each further shift register cell being coupled to one of the first conductors, the further shift register being arranged in parallel with the shift register.

The presence of a further shift register, which may be carried by the flexible substrate or which may be is carried by a second further flexible substrate, the second further flexible substrate being bonded to a second side of the flexible substrate, has a number of advantages. First of all, the lifetime of the display device can be extended by the presence of a second shift register, because the required operational time of the shift register functionality can be divided between the shift register and the further shift register, thus reducing the stress on the switches of the respective shift registers, which increases their lifetimes. Furthermore, the presence of a further shift register on the flexible substrate increases the production yield of the display device, because a fault in one of the shift registers no longer leads to the failure of the whole display device.

Advantageously, the shift register comprises a first plurality of connectors for connecting the shift register to external control circuitry, the further shift register comprises a second plurality of connectors for connecting the further shift register to external control circuitry and the display device further comprises a further plurality of connectors on a third side of the flexible substrate, the plurality of connectors being conductively coupled to the plurality of second conductors for connecting the second conductors of the display device to external control circuitry.

Such connectors, which may be male or female connectors, enable the facile replacement of the display device when it has reached the end of its life cycle.

According to another aspect of the present invention, there is provided electronic device comprising control circuitry for controlling a display device at least having the first plurality of connectors for connecting the shift register to external control circuitry and the further plurality of connectors for connecting the second conductors to external circuitry and a socket coupled to the control circuitry, the socket being arranged to interconnect the control circuitry to at least the first plurality of connectors and the further plurality of connectors.

Such an electronic device benefits from the display device of the present invention, because replacing the display device has become easier due to the limited number of connections. This improves the marketability of the electronic device.

The invention is described in more detail and by way of non-limiting examples with reference to the accompanying drawings, wherein:

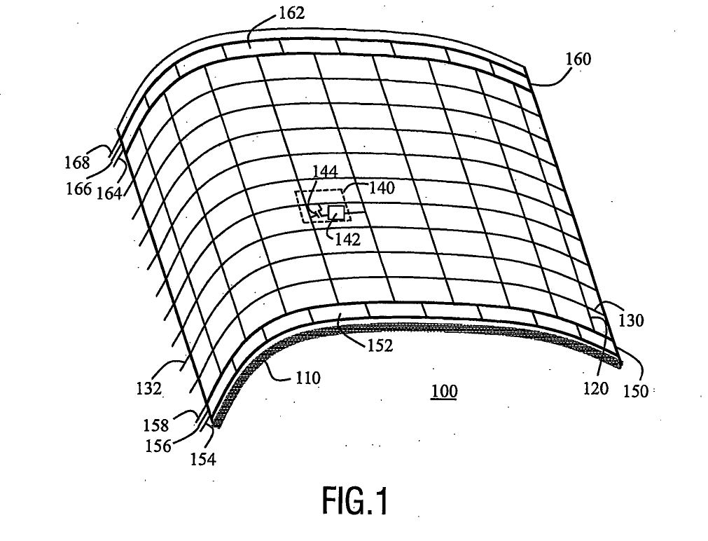

FIG. 1 depicts an embodiment of a display device of the present invention;

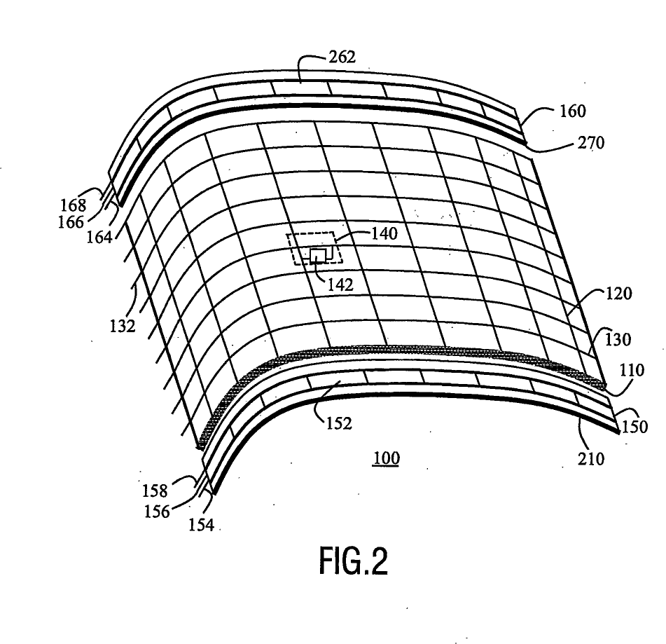

FIG. 2 depicts another embodiment of a display device of the present invention; and

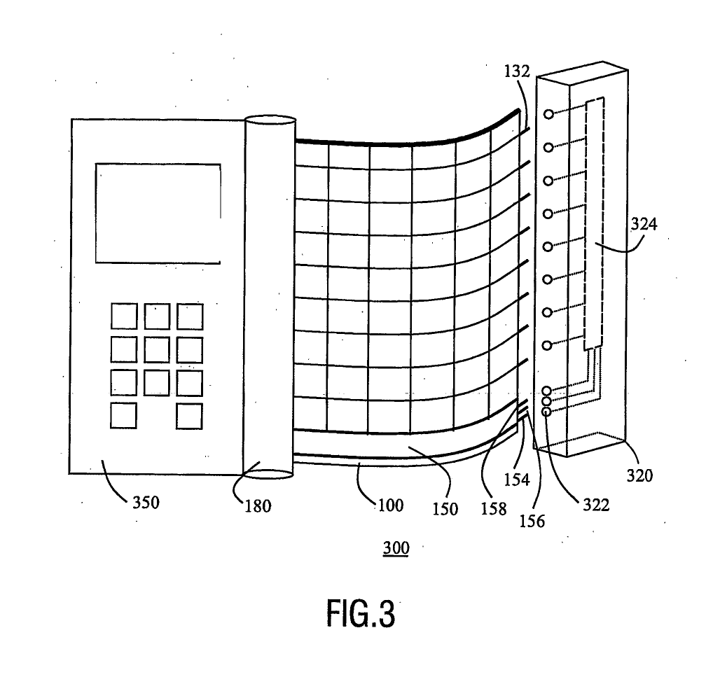

FIG. 3 depicts an electronic device of the present invention.

It should be understood that the Figures are merely schematic and are not drawn to scale. It should also be understood that the same reference numerals are used throughout the Figures to indicate the same or similar parts.

FIG. 1 depicts a flexible display device 100 of the present invention in a bent state. The display device 100 has a flexible substrate 110 carrying a matrix array. The flexible substrate 110 may be realized by using any suitable material, e.g., a suitable foil made from a polymer material such as polyimide. The matrix array typically includes a plurality of first conductors 120, and a plurality of second conductors 130, with each of the second conductors 130 crossing the plurality of first conductors 120. In the embodiment shown in FIG. 1, the first conductors 120 are row conductors and the second conductors 130.

In addition, the matrix array includes a plurality of pixels 140, each pixel 140 being located in the vicinity of a crossing of a first conductor 120 and a second conductor 130. The pixel 140 has an electro-optical element 142, which is addressable by the first conductor 120 and the second conductor 130. The electro-optical element 142 may include any suitable light valve material such as liquid crystals or an electrophoretic material, or may include a light-emitting polymer. Other embodiments of electro-optical elements 142, such as combinations of the aforementioned embodiments and light-sensitive elements are also feasible.

In the embodiment shown in FIG. 1, the pixel 140 further includes a switch 144 coupled between the associated second conductor 130 and the electro-optical element 142. The switch 144, which has a control terminal coupled to the associated first conductor 120, has an organic semiconductor material. The use of organic semiconductor materials is preferred, because the flexible substrate 110 is sensitive to heat and organic semiconductor materials can be processed on the flexible substrate 110 at relatively low temperatures. The use of organic semiconductor materials has the further advantage that it increases the flexibility of the switch 144. The presence of the switches 144 indicates that the matrix array of the display device 100 shown in FIG. 1 is of the active type, although it is emphasized that the use of a passive matrix array in the display device 100 is equally feasible. The switch 144 may be produced using known production techniques that are readily available to the skilled person. An example of such a technique can be found in Applied Physics Letters, Vol. 77, No. 10 pages 1487-1489 of 2000, as well as in the references therein.

The display device 100 further includes a flexible shift register 150 for addressing the plurality of first conductors 120, which is realized by the plurality of shift register cells 152 each being coupled to one of the first conductors. In this embodiment, the shift register 150 is integrated on the substrate 100, with the shift register cells 152 being realized in the same technology as the switches 144. It will be understood that additional flexible electronic components coupled to the shift register 150, e.g., buffers, may be present without departing from the scope of the present invention.

The presence of the flexible shift register 150 obviates the need for a bus structure to drive the plurality of first conductors 120. The shift register 150 is much smaller than a bus structure, which consequently leads to an increase of the area of the substrate 110 that can be used for laying out pixels 140. The shift register 150 has an optional first plurality of connectors 154, 156 and 158 for connecting the shift register to external control circuitry. Such connectors are required when it is foreseeable that the flexible display device 100 is to be used as a disposable device, in which case facile replacement is desirable. For such applications, a further plurality of connectors 132 for connecting the second conductors 130 to the external control circuitry will also be present.

In the first plurality of connectors, as few as three connectors may be sufficient, e.g., connectors 154 and 156 for providing the shift register 150 with a power supply binary data input and a connector 158 for providing the shift register 150 with a control input, e.g., a clock signal. The binary data input for the shift register may be provided via an additional connector (not shown) or may be generated by dedicated control circuitry (not shown) realized by flexible electronics. For instance, the data input of the shift register 150 may be coupled to a counter that generates a binary ‘1’ at each first clock pulse of a new row addressing cycle and a binary ‘0’ at all other clock pulses. It will be understood that such internal data signal generation is applicable when the first conductors 120 are row conductors. Consequently, the flexible shift register 150 yields a significant reduction in external connections compared to flexible displays having bus structures to provide the first conductors 120 with drive signals, where the number of external connections typically matches the number of first conductors 120. The fewer number of connectors 132, 154, 156 and 158 of the display device 100 means that the connectors can be laid out at a greater pitch, which enables a more facile replacement of the flexible display device 100 compared to flexible display devices carrying the aforementioned bus structures.

At this point it is emphasized that the first conductors 120 may also be column conductors without departing from the scope of the present invention. This can be advantageous if the pixels 140 are driven to an on-state or an off-state only, in which case binary data can be directly driven from the shift register 150 to the column conductors. Alternatively, flexible digital-to-analog conversion circuitry may be coupled between the shift register 150 and the first conductors 120.

In the embodiment shown in FIG. 1, an optional further flexible shift register 160 having shift register cells 162 and including an optional second plurality of connectors 164, 166 and 168 is also present on the flexible substrate 110 of the display device 100. The further shift register 160 is also realized in the same technology as the switches 144 of the pixels 140. The optional inclusion of the further shift register 160 at least serves two purposes.

Firstly, during operation of the display device 100, the driving of the first conductors 120 can be alternated between the flexible shift register 150 and the further flexible shift register 160. This is particularly advantageous in display applications requiring high picture refresh rates, because switches based on organic semiconductor materials are known to have deteriorating switching characteristics, e.g., drifting threshold voltages, when such switches are being biased for too long or when their on/off switching frequency becomes too high, thus preventing the switches to recover from each biasing period. Such deteriorations have a negative impact on the image quality as well as on the lifetime of the switches themselves. By multiplexing the driving signals between the flexible shift register 150 and the further flexible shift register 160, such negative effects are greatly reduced.

Secondly, the fabrication process of devices including switches based on organic semiconductor materials can suffer from low production yields due to the complexity of such processes. Obviously, the risk of low yields increases with an increase in the total number of switches that are integrated in the device. The flexible shift register 150 typically includes several thousands of these switches, which can introduce yield problems in non-optimal production processes for the display device 100. These problems can be reduced, and the yield can be improved, by the inclusion of the further flexible shift register 160, which is intended to be a redundant shift register. However, if testing of the display device 100 reveals that the flexible shift register 150 is faulty, the further flexible shift register 160 can be used as a back-up register.

FIG. 2 shows an alternative embodiment for improving the yield of the display device 100 of the present invention. In this embodiment, the matrix array of the display device 100 is a conventional passive matrix array, with electro-optical elements 142 in the pixels 140 being driven by the first conductors 120 and the second conductors 130. Again, this is by way of non-limiting example only; an active matrix array is equally feasible for this embodiment. The display device 100 also has a shift register 150, which is carried by a further flexible substrate 210 in this embodiment. The further flexible substrate 210 may be of the same material as substrate 110, although this is not necessary. The further substrate 210 is bonded to the substrate 110 using known bonding techniques such as adhesive bonding. Due to the use of a shift register 150 on a separate further substrate 210, the production process of the matrix array of the display device 100 and the shift register 150 have become separate processes, which has the advantage that a fault in one of the two parts of the display device 100 no longer leads to the loss of the whole display device. Also, the production of a separate shift register makes the production of passive matrix display devices 100 more cost-effective, because the matrix array of the display device 100 can be produced with simple production techniques rather than a complex technique that facilitates the production of the switches for the shift register 150.

Obviously, the optional further shift register 160 may also be realized on a second further flexible substrate 270.

FIG. 3 shows an example of an electronic device 300 that benefits from the display device 100 of the present invention. The electronic device 300 includes a cartridge 180 that is designed to hold the display device 100 in its rolled-up state. In addition, the electronic device 300 includes a control module 320, which includes the control circuitry 324 for controlling the display device 100, and a power supply (not shown) for powering the control circuitry 324. The control module 320 may be physically connected to a main unit 350 of the electronic device 300, in which case the cartridge 180 may be physically separated from the main unit 350, or the control module 320 may be physically separated from the main unit 350, in which case the control module 320 may be arranged to communicate with the main unit 350 using a wireless protocol.

The control module 320 includes a second further plurality of connectors 322, which are connected to the control circuitry for connecting the plurality of connectors 132, 154, 156 and 158 of the display device 100 to the control circuitry 324. Although not shown in this example, it will be obvious to the skilled person that the control module may also include connectors 322 for connecting the connectors 164, 166 and 168 of a further shift register 160 to the control circuitry 324. The control circuitry 324 typically includes column driver circuitry for driving control signals on the second conductors 130 of the display device 100 and row driver circuitry for providing the shift register 150 with clock signals, a power supply and, optionally, bit patterns for the shift register 150. The limited number of connectors 132, 154, 156 and 158 at the display device 100 facilitates easy replacement of the display device 100, thus improving the marketability of an electronic device 300 including such display devices.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A display device (100), comprising:
a flexible substrate (110) carrying a matrix array comprising:
a plurality of first conductors (120);
a plurality of second conductors (130), each of the second conductors crossing the plurality of first conductors (120); and
a plurality of pixels (140), each pixel being located in the vicinity of a crossing of a first conductor and a second conductor, the pixel comprising a electro-optical element (142) being addressable by the first conductor and the second conductor;
the display device (100) further comprising:
a flexible shift register (150) for addressing the plurality of first conductors (120), the flexible shift register (150) comprising a plurality of shift register cells (152), each shift register cell being coupled to one of the first conductors.

2. A display device (100) as claimed in claim 1, wherein each pixel (140) comprises a switch (144) coupled between the associated second conductor and the electro-optical element (142), the switch (144) comprising an organic semiconductor material and a control terminal coupled to the associated first conductor.

3. A display device (100) as claimed in claim 1, wherein each shift register cell (152) comprises a plurality of further switches, each further switch comprising a further organic semiconductor material.

4. A display device (100) as claimed in claim 3, wherein the shift register (150) is carried by the flexible substrate (110).

5. A display device (100) as claimed in claim 1, wherein the shift register (150) is carried by a further flexible substrate (210), the further flexible substrate (210) being bonded to a first side of the flexible substrate (110).

6. A display device (100) as claimed in claim 1, wherein the shift register (150) comprises a first plurality of connectors (154; 156; 158) for connecting the shift register (150) to external control circuitry.

7. A display device (100) as claimed in claim 1, wherein the display device (100) further comprises a further flexible shift register (160) for addressing the plurality of first conductors, the further flexible shift register (160) comprising a plurality of further shift register cells (162), each further shift register cell being coupled to one of the first conductors, the further shift register (160) being arranged in parallel with the shift register (150).

8. A display device (100) as claimed in claim 7, wherein the further shift register (160) is carried by the flexible substrate (110).

9. A display device (100) as claimed in claim 7, wherein the further shift register (160) is carried by a second further flexible substrate (270), the second further flexible substrate (270) being bonded to a second side of the flexible substrate (110).

10. A display device (100) as claimed in claim 7, wherein the further shift register (160) comprises a second plurality of connectors (164; 166; 168) for connecting the further shift register (160) to external control circuitry.

11. A display device (100) as claimed in claim 6, wherein the display device (100) further comprises a further plurality of connectors (132) on a third side of the flexible substrate (110), the plurality of connectors (132) being conductively coupled to the plurality of second conductors (130) for connecting the second conductors of the display device (100) to external control circuitry.

12. An electronic device (300) comprising:
control circuitry (324) for controlling a display device (100) as claimed in claim 11; and
a second further plurality of connectors (322) coupled to the control circuitry, the second further plurality of connectors (322) being arranged to interconnect the control circuitry (324) to at least the first plurality of connectors (154; 156; 158) and the further plurality of connectors (132).
